(19) United States
(12) Patent Application Publication
(10) Pub. No.: US 2025/0279420 A1
(43) Pub. Date: Sep. 4, 2025

(54) Stabilization of Lithium-Ion Batteries

(71) Applicant: Nissan North America, Inc., Franklin, TN (US)

(72) Inventors: Simran Kumari, Los Angeles, CA (US); Balachandran Guadaguntla Radhakrishnan, Palo Alto, CA (US); Masanobu Uchimura, Palo Alto, CA (US); Shigemasa Kuwata, Palo Alto, CA (US)

(21) Appl. No.: 18/592,019

(22) Filed: Feb. 29, 2024

(51) Int. Cl. H01M 4/525; H01M 4/02; H01M 4/38; H01M 4/583; H01M 10/0525; H01M 10/0568; H01M 10/0569

(52) U.S. Cl. CPC H01M 4/525; H01M 4/386; H01M 4/583; H01M 10/0525; H01M 10/0568; H01M 10/0569; H01M 2004/027; H01M 2004/028; H01M 2300/004

(57) ABSTRACT

A lithium-ion battery includes an anode including graphite and a cathode nickel in a mole percent of about 60 percent or more, based on the total composition of the cathode. The lithium-ion battery includes liquid electrolyte including one or both of ethyl methyl carbonate and ethylene carbonate and an oxidant that is soluble in the liquid electrolyte and binds with an alkene having between 2 and 4 carbon atoms.

### TECHNICAL FIELD

This disclosure relates to additives used to stabilize undesirable side reactions between liquid electrolyte derivatives and nickel cathodes.

### BACKGROUND

Lithium-ion batteries offer high-capacity batteries at relatively low cost. Advancements are constantly being made to improve the efficiency of various lithium-ion battery designs. In addition to improving capacity and cycling, techniques are being applied to decrease reactions between materials used in lithium-ion batteries. For example, one problem identified with lithium-ion batteries is the undesirable side reactions that cause production of hydrogen, various hydrocarbons, and carbon monoxide gases from interactions during cycling. The production of the hydrogen, the hydrocarbons, and the carbon monoxide can eventually lead to an increase in oxygen production within the lithium-ion battery. The buildup of oxygen can lead to a thermal runaway event that may negatively impact the lithium-ion battery or make the lithium-ion battery or adjacent lithium-ion batteries in a system inoperable. Accordingly, what is needed are one or more techniques to control side reactions in lithium-ion batteries.

### SUMMARY

Disclosed herein are implementations of a lithium-ion battery that include an anode including graphite and a cathode having nickel in a mole percent of about 80 percent or more, based on the total composition of the cathode. The lithium-ion battery includes a liquid electrolyte including one or both of ethylene carbonate and ethyl methyl carbonate and an oxidant that is soluble in the liquid electrolyte and binds with an alkene having between 2 and 4 carbon atoms.

In some implementations, the alkene may include between 2 and 3 carbon atoms. The alkene may include one or more of ethene, propene, and/or butene. The oxidant may be present in an amount of about 0.4 to about 2.1 weight percent, where the weight percent is based on the total weight the liquid electrolyte. The oxidant may include a metal oxide or salt thereof. The metal oxide may include two or more oxygen atoms. The metal oxide may include a metal selected from osmium, magnesium, iron, chromium, or any combination thereof. The metal oxide may include one or more of osmium oxide, potassium manganese oxide, iron oxide, chromium oxides, or any combination thereof. The anode may include silicon. The liquid electrolyte may include at least one more carbonate ester in addition to the ethylene carbonate. The cathode may further comprise oxygen and at least one of cobalt and manganese, wherein the cobalt and manganese are each present in a mole percent of 10 or less.

Disclosed herein is another implementation of a lithium-ion battery that includes an anode including graphite and a cathode including nickel in a mole percent of about 60 percent or more, based on the total amount composition of the cathode. The lithium-ion battery includes a liquid electrolyte comprising ethylene carbonate and a modified oxidant having oxygen atoms bound to a residue of hydrocarbon. The residue of the hydrocarbon is completely saturated and has between 1 and 4 carbon atoms.

In some implementations, the liquid electrolyte may be essentially free of alkenes that are residues of ethylene carbonate, other carbonate esters, or derivatives thereof. The liquid electrolyte may be essentially free of alkenes containing 2 to 4 carbons. The liquid electrolyte further may include dimethyl carbonate, ethyl methyl carbonate, propylene carbonate, diethyl carbonate, or any combination thereof.

Disclosed herein is another implementation of a lithium-ion battery that includes an anode including graphite and a cathode including nickel in a mole percent of 60 percent and oxygen, based on the total composition of the cathode. The lithium-ion battery includes a liquid electrolyte including one or more carbonate esters and an oxidant that is soluble in the liquid electrolyte and comprises two or more oxidizing groups that bind with an alkene having 2 between 2 and 4 carbon atoms.

In some implementations, the oxidant may include a metal, and the oxidizing group may include one or more of oxides. The oxidant may include a metal oxide. The one or more carbonate esters may include dimethyl carbonate, methyl ethyl carbonate, ethylene carbonate, propylene carbonate, diethyl carbonate, or any combination thereof.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-sectional schematic of a lithium-ion battery cell as assembled, as disclosed herein.

### DETAILED DESCRIPTION

Lithium-ion batteries of the present disclosure utilize nickel-based cathodes and graphite-containing anodes with a liquid electrolyte comprising at least one carbonate ester. During cycling, the anodes cause reduction of the carbonate esters to one or more of hydrocarbons and/or carbonyls at the graphite surface. Particularly, hydrocarbons that are unsaturated, such as alkenes, can bind with and attempt to extract nickel atoms from the cathode, and this effect can increase nickel/lithium cation exchange that further leads to an increased oxygen gas production from the cathode, which can lead to a thermal runaway event. Thermal runaway events can prevent further operation of the lithium-ion batteries.

One carbonate ester is ethylene carbonate. As the lithium-ion battery cycles, reduction at the graphite of the anode causes ethylene carbonate to reduce to lithium ethyl dicarbonate and ethene (i.e., C₂H₄), which is a hydrocarbon that is unsaturated. Ethene traverses from the anode to the cathode and binds with the nickel. Once the nickel and the ethene, also referred to as ethylene, are bound, the nickel is pulled from the lattice structure of the cathode and eventually causes a release of oxygen gas.

To mitigate the interactions between the ethene and nickel of the cathode, the present disclosure provides for an oxidant within the liquid electrolyte that binds with the ethene as the ethene is produced so that no binding occurs between the ethene and nickel. Once the oxidant and ethene bind, a modified oxidant is formed that eliminates the double bond between the carbons of the previous ethene. Without the extra electrons of the double bond of the ethylene, the modified oxidant does not bind with the nickel of the cathode and causes undesirable formation of oxygen gas.

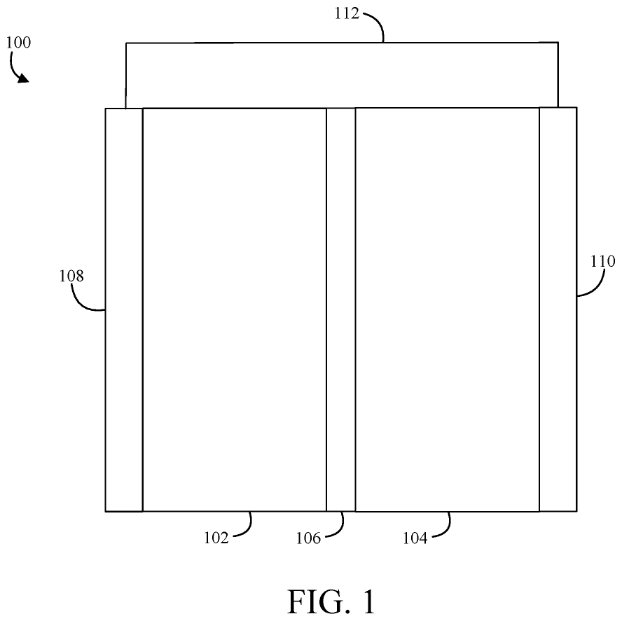

FIG. 1 illustrates is a cross-sectional schematic of a lithium-ion battery cell 100 as assembled. The lithium-ion battery cell 100 includes an anode 102 and a cathode 104 that are separated by an optional separator 106. The anode 102 is connected with an anode current collector 108, and the cathode is connected with a cathode current collector 110, which is electrically connected through a connector 112 to the anode current collector 108. Dispersed within the lithium-ion battery cell 100, a liquid electrolyte is included that is configured to facilitate lithium ions between the anode 102 and cathode 104. The liquid electrolyte includes the oxidant from assembly of the lithium-ion battery cell 100, and the oxidant may be dissolved within or dispersed throughout the liquid electrolyte. A lithium-ion battery is formed of multiple lithium-ion battery cells 100.

The oxidant is configured to cause reduction of hydrocarbons that are unsaturated, such as alkenes, to form modified oxidants so that the hydrocarbons do not undesirably interact or bind with the nickel of the cathode. The present disclosure aims to reduce the amount of hydrocarbons present in the lithium-ion battery cells by targeting specific hydrocarbons with the oxidants to form modified oxidants. Particularly, the hydrocarbons are unsaturated hydrocarbons, such as alkenes. Specific alkenes formed from reduction of carbonate esters at the graphite surface of the anode may include one or more of ethene, propene, butene, pentene, and/or hexene. The alkene may have the following structure of formula (I):

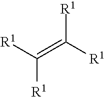

wherein each R₁ independently comprises hydrogen, methyl, ethyl, propyl, or butyl.

The oxidant may include an oxide configured to bind with an alkene. The oxidant may include one or more oxidizing groups configured to bind with an alkene, such as one or more oxides. The oxidant may include a metal oxide or salt thereof. The oxidant may include a metal and two or more oxygen atoms, and at least some of the oxygen atoms may be configured to bind with separate carbon atoms of the alkene. The oxidant may include a compound with an anionic charge that is balanced by one or more counter ions, such as potassium or sodium, to form a salt. The oxidant may include osmium oxide, iron oxide, potassium manganese oxide, chromium oxide, or any combination thereof. The oxidant may have a formula of M((R²)ₓ)^{y}. M includes osmium, iron, manganese, or chromium. Each R² may independently include oxygen. Each x may be an integer from 1 to 6. Each y may be a negative charge of −1 to −3. The oxidant may have the following structure of formula (II):

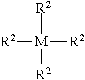

wherein R² each independently comprises oxygen, and optionally is not present; and wherein M comprises osmium, iron, manganese, or chromium.

The oxidant may be soluble in the liquid electrolyte at a desirable weight percent, based on the total weight of the liquid electrolyte. The oxidant may be present in a weight percent sufficient to binds with substantially all (i.e., 90% to 99.9%) of the total alkenes formed in the lithium-ion battery cells from reduction of the carbonate esters at the graphite surface of the anode. For example, the oxidant may be present in a weight percent of 0.0001 percent to about 5 percent, based on the total weight of the liquid electrolyte. In some examples, the oxidant may not be soluble in the liquid electrolyte and may be instead dispersed as a solid throughout the liquid electrolyte or elsewhere in the lithium-ion battery cell, such as in portions of the separator 106.

The modified oxidant may have a structure that is free of carbon-carbon double bonds. The modified oxidant may include hydrocarbons or residues thereof that are completely saturated such that modified oxidant does not undesirably bind with nickel atoms in the cathode. The modified oxidant may be a cyclic ring that includes fully saturated carbon atoms. The modified oxidant may include a reside of the oxidant (e.g., a metal oxide) and residue a hydrocarbon that is unsaturated (e.g., an alkene). The liquid electrolyte may include two or more different modified oxidants that are based on residues of different alkenes and/or different oxidants. The modified oxidant may include a structure of formula (III):

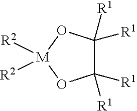

wherein R¹ each independently comprises hydrogen, methyl, ethyl, propyl, or butyl; wherein R² each independently comprises oxygen and optionally is not present; and wherein M comprises osmium, iron, manganese, or chromium.

The electrolyte is a liquid at ambient conditions. The liquid electrolyte may include one or a combination of liquid electrolytes, and the oxidants described herein may be configured to bind with one or more different alkenes that are derived from reduction of different liquid electrolytes at the graphite surface of the anode. While the oxidant is present, the liquid electrolyte may be essentially free of alkenes that are residues of carbonate esters or derivatives thereof.

The liquid electrolyte may include one or more carbonate esters. The liquid electrolyte may include at least ethylene carbonate and optionally one or more additional carbonate esters or other liquid electrolytes. Carbonate esters may include one or more of ethylene carbonate (EC), ethyl methyl carbonate (EMC), dimethyl carbonate (DMC), trimethylene carbonate, diethyl carbonate, methyl ethyl carbonate, propylene carbonate, diethyl carbonate, or any combination thereof. In addition to the one or more carbonate esters, one or more additional solvents may be included, such as cyclic ethers (e.g., tetrahydrofuran (THF) or tetrahydropyran (TH), glymes (e.g., dimethoxyethane (DME) or diethoxyethane), ethers (e.g., diethylether (DEE) or methylbutylether (MBE)), derivatives thereof, or any combination thereof.

Where a separator 106 is used, such as with a liquid or gel electrolyte, the separator can be a polyolefin or a polyethylene, as non-limiting examples.

The anode current collector 108 can be, as a non-limiting example, a sheet or foil of stainless steel, copper, nickel, a copper-nickel alloy, carbon paper, or graphene paper.

The cathode current collector 110 can be, as a non-limiting example, an aluminum sheet or foil, carbon paper or graphene paper.

The cathode active material layer of the cathode 104 has cathode active material that can include one or more lithium transition metal having at least nickel and oxygen and optionally manganese and/or cobalt. The lithium transition metal oxides may include mole percent of nickel in an amount of at least 60 mole percent to about 90 mole percent, based on the total composition of the cathode active material. The lithium transition metal oxides may include mole percent of cobalt and/or manganese in an amount of at about 1 mole percent to about 30 mole percent, based on the total composition of the cathode active material. Lithium transition metal oxide examples include LiNiO₂,Li(Ni_{0.5}Mn_{0.5})O₂, LiNiₓCo_{y}Mn₂O₂, and LiNi_{0.8}Co_{0.15}Al_{0.05}O₂.

The anode active material layer of the anode 102 includes at least a natural and/or artificial graphite material. Optionally, the anode active material layer may additionally include one or more of graphene, mesocarbon microbeads, needle coke, carbon particles, carbon fibers, carbon nanotubes, and carbon nanofibers. Optionally, the anode active material layer may additionally include silicon, germanium, tin, lead, antimony, bismuth, zinc, aluminum, nickel, cobalt, manganese, titanium, iron, cadmium, alloys thereof, or combinations thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lithium-ion battery, comprising:
an anode comprising graphite;
a cathode comprising nickel in a mole percent of about 80 percent or more, based on the total composition of the cathode;
a liquid electrolyte comprising:
one or both of ethylene carbonate and ethyl methyl carbonate; and
an oxidant that is soluble in the liquid electrolyte and configured to bind with an alkene having between 2 and 4 carbon atoms.

2. The lithium-ion battery of claim 1, wherein the alkene comprises between 2 and 3 carbons.

3. The lithium-ion battery of claim 1, wherein the alkene comprises one or more of ethene, propene, and/or butene.

4. The lithium-ion battery of claim 1, wherein the oxidant is present in an amount of about 0.4 to about 2.1 weight percent, wherein the weight percent is based on the total weight the liquid electrolyte.

5. The lithium-ion battery of claim 1, wherein the oxidant comprises a metal oxide or salt thereof.

6. The lithium-ion battery of claim 5, wherein the metal oxide comprises two or more oxygen atoms.

7. The lithium-ion battery of claim 6, wherein the metal oxide comprises a metal selected from osmium, magnesium, iron, chromium, or any combination thereof.

8. The lithium-ion battery of claim 1, wherein the metal oxide comprises one or more of osmium oxide, potassium manganese oxide, iron oxide, chromium, or any combination thereof.

9. The lithium-ion battery of claim 1, wherein the anode further comprises silicon.

10. The lithium-ion battery of claim 1, wherein the liquid electrolyte includes at least one more carbonate ester in addition to the ethylene carbonate.

11. The lithium-ion battery of claim 1, wherein the cathode further comprises oxygen and at least one of cobalt and manganese, wherein the cobalt and manganese are each present in a mole percent of 10 or less.

12. A lithium-ion battery, comprising:
an anode comprising graphite;
a cathode comprising nickel in a mole percent of about 60 percent or more, based on the total amount composition of the cathode;
a liquid electrolyte comprising ethylene carbonate; and
a modified oxidant having oxygen atoms bound to a residue of hydrocarbon, wherein the residue of the hydrocarbon is completely saturated and has between 1 and 4 carbon atoms.

13. The lithium-ion battery of claim 12, wherein the liquid electrolyte is essentially free of alkenes that are residues of ethylene carbonate, other carbonate esters, or derivatives thereof.

14. The lithium-ion battery of claim 13, wherein the liquid electrolyte is essentially free of alkenes containing 2 to 4 carbons.

15. The lithium-ion battery of claim 12, wherein the liquid electrolyte further comprises dimethyl carbonate, ethyl methyl carbonate, propylene carbonate, diethyl carbonate, or any combination thereof.

16. The lithium-ion battery of claim 12, wherein the modified oxidant, comprises: 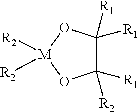
wherein R¹ each independently comprises hydrogen, methyl, or ethyl;
wherein R² each independently comprises oxygen and optionally is not present; and
wherein M comprises osmium, iron, manganese, or chromium.

17. A lithium-ion battery, comprising:
an anode comprising graphite;
a cathode comprising nickel in a mole percent of 60 percent and oxygen;
a liquid electrolyte comprising one or more carbonate esters;
an oxidant that is soluble in the liquid electrolyte and comprises two or more oxidizing groups configured to bind with an alkene having 2 between 2 and 4 carbon atoms.

18. The lithium-ion battery of claim 17, wherein the oxidant comprises a metal, and wherein the oxidizing group comprises one or more of oxides or any combination thereof.

19. The lithium-ion battery of claim 18, wherein the oxidant comprises a metal oxide.

20. The lithium-ion battery of claim 17, wherein the one or more carbonate esters comprise dimethyl carbonate, methyl ethyl carbonate, ethylene carbonate, propylene carbonate, diethyl carbonate, or any combination thereof.
